(19) United States
(12) Patent Application Publication
(10) Pub. No.: US 2015/0027320 A1
(43) Pub. Date: Jan. 29, 2015

(54) Cookware with heat source under audible feedback control

(71) Applicant: Meyer Intellectual Properties Limited, Kowloon (HK)

(72) Inventors: Stanley Kin Sui Cheng, Hillsborough, CA (US); Frank Chun Wing Wong, Hong Kong (CN)

(21) Appl. No.: 14/376,599

(22) PCT Filed: Feb. 22, 2013
(86) PCT No.: PCT/US2013/027372

§ 371 Date: Aug. 4, 2014

Related U.S. Application Data
(60) Provisional application No. 61/602,961, filed on Feb. 24, 2012.

(51) Int. Cl. A47J 27/56; A47J 27/00

(52) U.S. Cl. CPC A47J 27/56; A47J 27/004
USPC 99/331

(57) ABSTRACT

A cookware article for use on an electronically controllable heat source, such as an induction stovetop, has a tight fitting lid that include a whistle that is activated by the steam pressure when water boils. The electronically controllable heat source is operative to reduce the power in response to the whistle so that the water temperature is lowered to a power setting for simmering or the appropriate cooking method after the water boils.

### CROSS REFERENCE TO RELATED APPLICATIONS

The present application claims the benefit of priority to the PCT application No. PCT/2013/027372, which was filed on 22 Feb. 2013, and which in turn claims the benefit of priority to the US patent application of the same title that was filed on 24 Feb. 2012, having application Ser. No. 61/602,961, and are both incorporated herein by reference.

### BACKGROUND OF INVENTION

The present invention relates to an improved method of cooking, and in particular to cookware heating source that are responsive to the cookware.

Prior methods of cooking deploy thermocouples or thermometers to measure either the temperature of the vessel, or the foodstuff therein to cook at a fixed temperature.

In some types of food preparation, it is desirable that the water be heated to a boil before the temperature is lowered. The detection of boiling, from a cooking perspective, is not simply the issue of water reaching the boiling temperature, but that the pot or vessel has received sufficient energy such that the quantity of steam bubbles produced in the water provides violent agitation, which is generally referred to as a rolling boil.

In addition, it is frequently desirable to reduce the heat applied after a rolling boil is obtained to simmer the foodstuffs in the pot, or after subsequent cooling from the addition of cool ingredients, to then return the contents to a boil.

Whistles are traditionally used to determine when water in a teapot has boiled. Whistles have also been deployed in the lids of cookware. Pressure cookers in fact produce an audible sound, not unlike a whistle, when steam escapes to control pressure.

Cook's frequently waste time waiting for water to boil in open vessel or pots, when they could be more productive using there time on other tasks, and are frequently need to interrupt these other tasks to check and see if indeed the water has boiled. This is fairly important in cooking rice and some noodles and pasta for example; as the temperature should be lowered after a boil is reached with the ingredients in the vessel.

It is therefore a first object of the present invention to provide a cooking device that provides the above benefits to the user.

Having a means for automated detection of water boiling in a cooking vessel, and the subsequent automated control of the cooking temperature would provide several advantages to cooks, such as the faster and improved preparation of pasta, rice as well as making it easier for a cook to multi-task in the kitchen.

### SUMMARY OF INVENTION

In the present invention, the first object is achieved by a cooking system comprising a heat source powered via a controller, a cookware vessel having a tight fitting lid and a steam activated whistle in the lid, wherein the controller is operative to modulate the power to the heat source in response to the noise generated by the steam activated whistle.

A second aspect of the invention is characterized by an induction cooking system comprising an induction burner base having at least one coil powered via a controller, a cookware vessel having a tight fitting lid and a steam activated whistle in the lid wherein the controller is operative to modulate the power to the induction burner in response to the noise generated by the steam activated whistle.

The above and other objects, effects, features, and advantages of the present invention will become more apparent from the following description of the embodiments thereof taken in conjunction with the accompanying drawings.

### BRIEF DESCRIPTION OF DRAWINGS

FIG. 1 is a cross-sectional elevation of a preferred cookware vessel for use with the heater shown in FIG. 2.

FIG. 2 is a block functional diagram of a heater that is operative in response to the direct input of the user as well as feedback from the cookware vessel.

FIGS. 3A and 3B are cross-sectional elevation of the whistle in FIG. 1, in which FIG. 3B is enlarged to show detail of the whistle construction.

### DETAILED DESCRIPTION

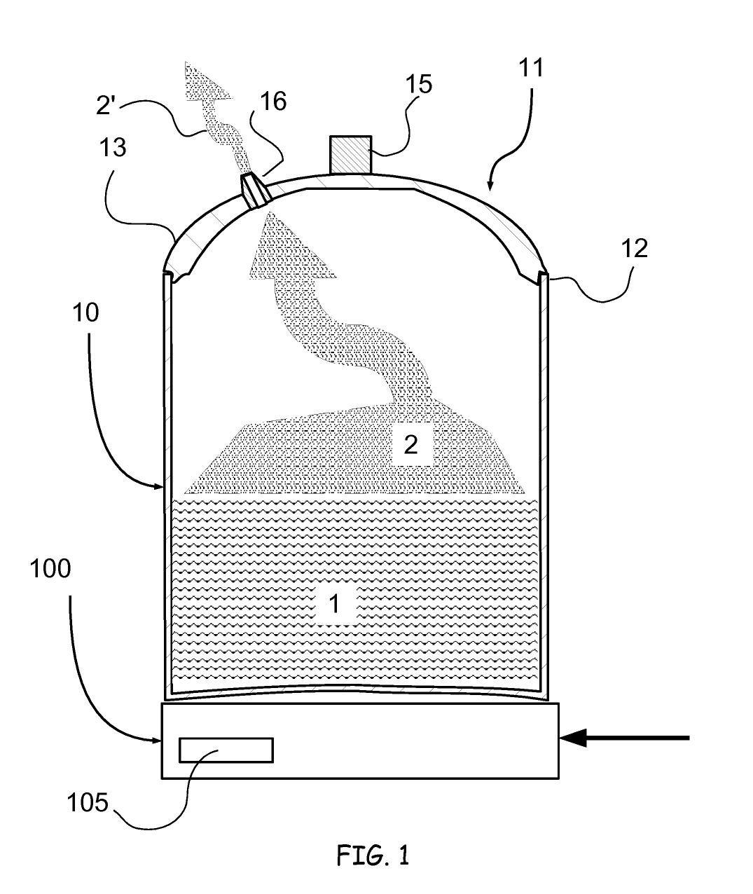

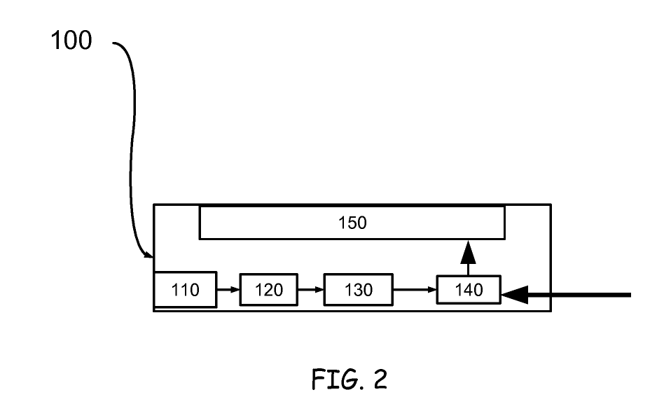

Referring to FIGS. 1 through 3, wherein like reference numerals refer to like components in the various views, there is illustrated therein a new and improved Cookware with heat source with audible feedback control, the heat source being generally denominated 100 herein.

In accordance with the present invention, as illustrated in FIG. 1, there is a heat source 100 that support and provides energy to cookware vessel 10. The cookware vessel 10 is covered by a tight fitting lid 11, which forms a substantially vapor tight seal with the rim 12 of vessel 10 at its' own rim 13. The lid 11 has a handle 15 and a whistle 16 that is steam activated. The steam 2 is generated by the boiling of water 1 in vessel 10, caused by heating element 150 of heat source 100. As further described below, the heat source 100 has a sound detection means that is operative to reduce power in response to “hearing” a whistle. Heat source 100 also preferably has an external control panel 150.

The whistle 16 has a constricted exit orifice through which steam 2 escapes to the volume external to the vessel 10 and lid 11 (shown as 2′) wherein this flow of steam produces detectable sound. The sound quality is partly determined by deploying a cavity before the exit orifice, where the entrance of steam to this cavity is a first or entrance orifice.

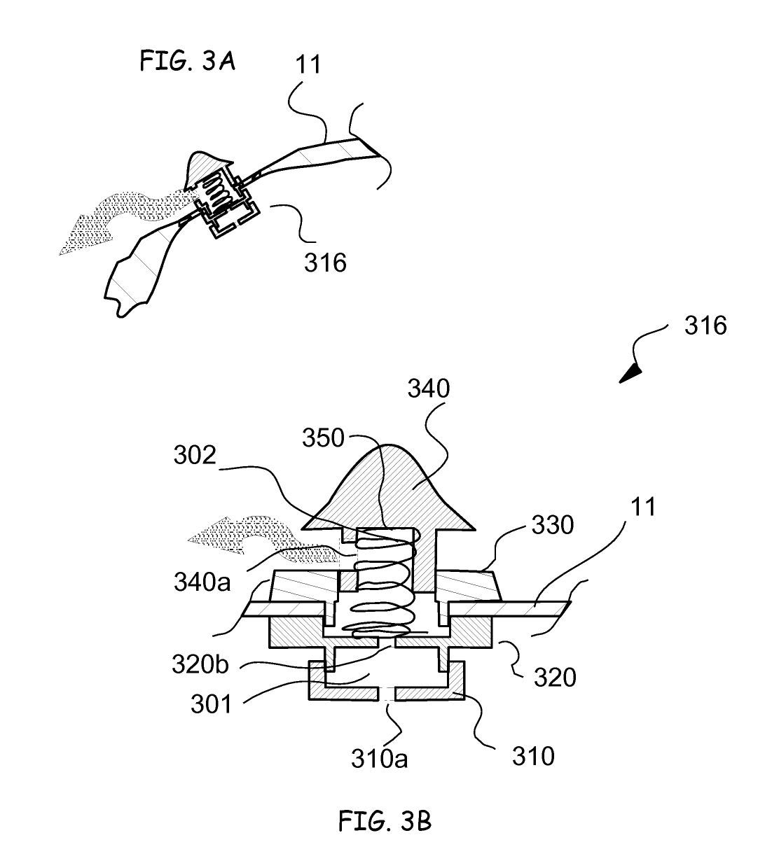

FIGS. 3A and 3B are cross-sectional elevations of such a whistle 316. Cavity 301 and cavity 302 are defined by concentric threaded fitting 310, 320 and 330, with the outer orifice 340a from outer cavity 302 direct to point sideways by a cap 340 that engages the upper concentric fitting 330. The upper 330 and mid 320 concentric fittings engage to seal the penetration in the lid wall, whereas the lower concentric fitting provides the first or inner orifice 310a for steam to enter cavities 301 and 302. Optionally, a spring 350 can be used to support cap 340 upward to open orifice 340a, or the cap 340 can be rotated and locked into a lower portion of the mid concentric fitting 330 to close the outer orifice 340a. A mid orifice 320b is disposed above the lower cavity 301, being provided within the center of the mid concentric fitting. The mid orifice 320b is narrow than the outer orifice 340a, which hence along with orifice 310a and lower cavity 301 primarily defines the whistle sound characteristic.

Ideally the sound is also at a frequency and volume to be audible, but more significantly is readily discerned from kitchen background noises, such as speech, noise form fans and the motors of other electronic appliances, and the like.

Among the various benefits of the invention that particularly accrue when the heating source is an induction burner is the faster preparation of pasta, as water in the vessel will come to a boil very quickly at full power, due to the high efficiency of induction heating of the cookware, even before pasta is added. Traditionally, the pasta is only added after the water in the pot comes to a rolling boil. However, as the cool pasta usually causes the water to cease boiling, depending on the quantity of pasta to cease, a cook waits for the water to return to a second boil, before turning the power down so that the water simmers. Salt and oil are added by some cooks either before or after adding the pasta.

The quality and consistency of the cooked pasta can be improved, if the temperature can be reduced as soon as the water returns to a boil, and the total heating time can be tracked to avoid overcooked. This is particularly critical for ravioli or other stuffed or filled pasta, which can explode if the water is boiling to vigorously for an excessive amount of time. Hence, automated detective of a first and second boil can provide a more productive use of the cook's time than watching or waiting for water to boil or return to a boil and then having to reduce the heat to the cookware so the pasta or other food only simmers. Further, the automated control of power to the cooking vessel as described herein also makes it easier for a cook to multi-task in the kitchen.

More specifically, the means for electronically controlling the heat source 100 via whistle sound detection and subsequent power reduction first require the detection of the whistling sound based on an audible sensor detecting a noise meeting a threshold criterion of at least one of volume and frequency. Therefore a sound transducer 110, which can be a microphone, is deployed to pick up the sound to transform it into electrical signals for further processing, such as by a microprocessor device, or general purpose computing device that is programming or the specific purposes disclosed herein. A preamplifier and/or amplifier stage 120 with automatic gain control (AGC) is preferably deployed to pre-condition the signal to suitable level for recognition purposes.

Tone decoders 130 (such as an array of band pass filters) can then be used to categorize the sound detected into narrow frequency bands for comparison against known whistle sound pattern. Then a controller/microprocessor 140 is deployed to analyze the duration and/or frequency purity to discriminate the whistle sound against human speech, music, as well as other background noise that may be present in the environment, and may optionally determine and adjust for sampling errors and the like. The controller/microprocessor 140 may then optionally adjust the output power of the burner downward to confirm the whistle sound characteristics detected if required.

Another aspect of the invention is that the heater 100, such as an induction burner, has operating modes accessed by the same or a different controller/microprocessor 140 for cooking specific foods or cooking modes, in which operating/cooking modes can selected by the control panel 150.

An induction burner is a preferred heat element 100, that more preferably also includes at least one of IR sensors or thermocouples to also monitor the temperature of the cooking vessel 10 or the contents therein, and causes rather rapid and immediate change to the heat delivered to the cooking vessel 10.

It should be appreciated that the controller/microprocessor 140 is preferably programmed to differentiate the sound of the whistle sound from background noise, and that such programming may include also considering as background noise, all sounds that occur before the water could possibly reach the boiling point, such as when the temperature as measured by IR or other means is well below the boiling point, as well as a conditioning time between activating the heat sources 100 and powering the heating element 150.

Hence, it is also desirable that the controller/microprocessor is operative to develop a background noise profile used to discriminate the whistle sound from the background during a predetermined time period prior to the potential boiling of the fluid in the vessel. The time period may be predetermined from experience of prior heating cycles, or when the detected vessel temperature is approaching, but not close enough to the boiling point. By developing the background noise profile immediately before boiling is likely to be detected, it is also or the controller/microprocessor to determine that the current background noise is to large to accurately detect boiling by distinguishing the whistling characteristics, in which case it would be desirable if the system is operative to alert a user that the detected background noise is too large to be distinguished from a whistle sound, and that the system will not operate in the desired automated boil detection and control mode. In determining the duration of this background noise detection period, the temperature measurement can be made by a sensor immersed in the fluid/water contained in the vessel, or a thermal sensor built into the inner wall of the vessel. Such temperature measurements can also be used in any of the cooking modes described below, such as when the vessel is maintained at a lower predetermined temperature after boiling.

The heat source 100 can be any burner with its output power controlled electronically. An induction burner has an advantage that its power output can be switched on/off instantly for optimal control but gas burner (with electronically controlled valve and ignition system) offers similar performance.

It should be appreciated that the above aspects and features enable the following modes of cooking:

A. Pasta cooking, in which the water is brought to a boil, and the user is alerted so they can then add the pasta. Then after water cools from the pasta and comes to a 2nd boil, the temperature or power is reduced or the user is alerted to observe the effects of the power reduction, or to manually reduce the power as desired. The user optionally indicates when pasta is added so the power returns to high to reheat the water to boiling, as well as for signaling when the pasta is completed, such as by the user setting a timer or pasta type via the control panel. The independent temperature sensors can also be used to monitor the subsequent cooling from adding pasta, and the reheating.

B. Rice Cooking, in which the temperature is lowered after a simmer or boil is reached, and may optionally progress according to a predetermined time-temperature profile, such as to lower temperature keep the rice warm after cooking without drying, as well as provide an audible or/and or visual signal after cooking is complete

C. Boil, and then immediately turn off, (Auto Off);

D. Boil and then automatically simmer until manually shut off, or for a predetermined time programmed by the user.

E. Simmer until manually shut off, or for a predetermined time programmed by the user.

F. Any of the above modes A-E under either temperature monitored control, wherein the temperature is used to control the power level, such as under proportion-derivative-integral (PID) control to heat the contents to the predetermined or predetermined time temperature profile, or power mode, where the power is either constant or varies with time per a predetermined profile.

While the invention has been described in connection with a preferred embodiment, it is not intended to limit the scope of the invention to the particular form set forth, but on the contrary, it is intended to cover such alternatives, modifications, and equivalents as may be within the spirit and scope of the invention as defined by the appended claims.

1. An cooking system comprising:
a) a heat source powered via a controller,
b) a cookware vessel having:
i) a lid for covering the lid, and
ii) a steam activated whistle in the lid,
c) wherein the controller is operative to modulate the power to the heat source in response to the noise generated by the steam activated whistle.

2. The cooking system of claim 1 further comprising a means to measure the temperature of at least one of the cooking vessel and the contents of the vessel wherein the controller is further operative to modulate the power to the heat source in response to the measured temperature.

3. The cooking system of claim 1 wherein the controller is further operative to modulate the power to the heat source on detection of a second boiling event.

4. The cooking system of claim 2 further comprising a means to measure the temperature of at least one of the cooking vessel and the contents of the vessel wherein the controller is further operative to modulate the power to the heat source in response to the measured temperature.

5. The cooking system of claim 1 wherein the controller comprises a tone decoder that is operative to quantify the sound acquired during heating to detect the characteristic sounds generated by the steam activated whistle.

6. The cooking system of claim 1 wherein the controller/microprocessor is operative to compare the output of the tone decoder to a reference signal profile characteristic of the whistle's output during boiling.

7. The cooking system of claim 5 wherein the controller/microprocessor is operative to subtract a background noise profile from the tone decoder output prior to the comparison to the reference signal profile to determine when boiling has occurred.

8. The cooking system of claim 6 wherein the controller/microprocessor is operative to develop the background noise profile during a predetermined time period prior to the potential boiling of the fluid in the vessel.

9. The cooking system of claim 6 wherein the controller/microprocessor is operative to alert a user that the detected background noise is too large to be distinguished from a whistle sound, and that the system will not operate in the desired automated boil detection and control mode.

10. An induction cooking system comprising:
a) an induction burner base having at least one coil powered via a controller,
b) a cookware vessel having:
i) a lid for covering the cookware vessel, and
ii) a steam activated whistle in the lid,
c) wherein the controller is operative to modulate the power to the induction burner in response to the noise generated by the steam activated whistle.

11. The induction cooking system of claim 10 further comprising a means to measure the temperature of at least one of the cooking vessel and the contents of the vessel wherein the controller is further operative to modulate the power to the heat source in response to the measured temperature.

12. The induction cooking system of claim 10 wherein the controller is further operative to modulate the power to the heat source on detection of a second boiling event.

13. The induction cooking system of claim 12 further comprising a means to measure the temperature of at least one of the cooking vessel and the contents of the vessel wherein the controller is further operative to modulate the power to the heat source in response to the measured temperature.

14. The induction cooking system of claim 10 wherein the controller comprises a tone decoder that is operative to quantify the sound acquired during heating to detect the characteristic sounds generated by the steam activated whistle.

15. The induction cooking system of claim 10 wherein the controller/microprocessor is operative to compare the output of the tone decoder to a reference signal profile characteristic of the whistle's output during boiling.

16. The induction cooking system of claim 15 wherein the controller/microprocessor is operative to subtract a background noise profile from the tone decoder output prior to the comparison to the reference signal profile to determine when boiling has occurred.

17. The induction cooking system of claim 16 wherein the controller/microprocessor is operative to develop the background noise profile during a predetermined time period prior to the potential boiling of the fluid in the vessel.

18. The induction cooking system of claim 16 wherein the controller/microprocessor is operative to alert a user that the detected background noise is too large to be distinguished from a whistle sound, and that the system will not operate in the desired automated boil detection and control mode.
